(19) United States
(12) Patent Application Publication
(10) Pub. No.: US 2006/0055976 A1
(43) Pub. Date: Mar. 16, 2006

(54) Printer, image output apparatus, and method for guide to slot of recording medium

(75) Inventor: Hitoshi Ueno, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/227,150

(22) Filed: Sep. 16, 2005

(30) Foreign Application Priority Data
Sep. 16, 2004 (JP) 2004-269633

(51) Int. Cl. G06K 15/00

(52) U.S. Cl. 358/1.16

(57) ABSTRACT

The present invention provides a printer comprising: an image read unit which has a slot corresponding to a type of recording medium, and reads an image from a recording medium inserted into the slot; an image obtaining unit which obtains an image showing a shape of the recording medium; an identifying unit which identifies the type of recording medium based on the image showing the shape of the recording medium; a guide unit which guides to and displays a slot corresponding to the identified type; and a print unit which prints the image read from the recording medium, in order to prevent wrong insertion of the recording medium.

### BACKGROUND OF THE INVENTION

1. Field of the Invention

The present invention relates to a printer, an image output apparatus, and a method for guide to a slot of a recording medium, and more specifically to a guide to a slot of a recording medium in a printer for printing an image taken by a digital camera, a mobile telephone with a camera, etc. at a storefront.

2. Description of the Related Art

Conventionally, various printers for printing various types of printing by reading an image from a recording medium recording an image taken by various kinds of imaging devices such as a digital camera, a mobile telephone, etc. have been developed. For example, an image information reception device disclosed by Japanese Patent No. 3469741 displays an image showing the shapes and the model numbers of various types of digital cameras on the display so that a user can select and touch the figure of the shape of the digital camera of the user. Next, the type of the recording medium corresponding to the selected shape of digital camera is identified, and the shutter of the slot of a recording medium corresponding to the identified type of recording medium is opened to blink the flicker, thereby guiding a recording medium to be inserted into the slot of a recording medium.

### SUMMARY OF THE INVENTION

Recently, the type of recording medium is increasing, and a user cannot correctly recognize the type of recording medium and frequently inserts a recording medium into a wrong slot not corresponding to the type of the recording medium of the user, which causes a fault of a printer. In this respect, when a user mistakenly selects the type of digital camera on the image information reception device of Japanese Patent No. 3469741, the medium is guided to a wrong slot, and cannot be protected against wrong insertion of a recording medium. The present invention has been developed to solve the problem, and aims at providing a printer capable of appropriately guiding a recording medium of any type to a correct slot.

To attain the above-mentioned objective, the printer according to the present invention includes: an image read unit which has a slot corresponding to a type of recording medium, and reads an image from a recording medium inserted into the slot; an image obtaining unit which obtains an image showing a shape of the recording medium; an identifying unit which identifies the type of recording medium based on the image showing the shape of the recording medium; a guide unit which guides to and displays a slot corresponding to the identified type; and a print unit which prints the image read from the recording medium.

The printer identifies the type of recording medium based on the image showing the shape of the recording medium, and guides to and displays a slot corresponding to the identified type. That is, since the type of recording medium can be automatically identified and a user is guided to a correct slot corresponding to the type of the recording medium, the user can be protected against insertion of a recording medium into a wrong slot.

The guide unit can display an identified type on the display device, turn on the lighting device provided near the slot corresponding to the identified type, or open the shutter at the slot corresponding to the identified type.

The printer can also be provided with a storage unit for storing a table defining the correspondence between the type of recording medium and the number of pixels of the image showing the shape of the recording medium. The identifying unit can identify the type of recording medium according to the number of pixels of the image shoring the shape of the recording medium and the table.

Also to attain the above-mentioned objective, the method for guide to a slot of a recording medium according to the present invention includes: an image obtaining step of obtaining an image showing a shape of the recording medium; a designating step of designating the type of recording medium based on the image showing the shape of the recording medium; and a guide step of guiding to and displaying a slot corresponding to the identified type.

In addition, to attain the above-mentioned objective, the image output apparatus according to the present invention includes: an image read unit which has a slot corresponding to a type of recording medium, and reads an image from a recording medium inserted into the slot; an image obtaining unit which obtains an image showing a shape of the recording medium; an identifying unit which identifies the type of recording medium based on the image showing the shape of the recording medium; a guide unit which guides to and displays a slot corresponding to the identified type; and an image output unit which outputs the image read from the recording medium.

The image output apparatus has the same operation effect as the above-mentioned printer. The image output unit can be means for externally outputting an image read from various medium drives such as a CD-R drive, etc. and a recording medium such as various radio and cable communication devices, etc.

The printer, the image output apparatus, and the method for guide to a slot of a recording medium according to the present invention identify the type of recording medium based on the image showing the shape of the recording medium, and guide to and display a slot corresponding to the identified type. That is, since the type of recording medium is automatically identified, and a correct slot corresponding to the type of the recording medium can be guided to, a user can be prevented from inserting a recording medium into a wrong slot.

### BRIEF DESCRIPTION OF THE DRAWINGS

FIG. 1 is a block diagram of the printer according to a preferred embodiment of the present invention;

FIG. 2 shows the appearance of a slot;

FIG. 3 shows an image obtained by capturing the shape of a recording medium;

FIG. 4 is a flowchart of the recording medium recognizing process;

FIG. 5 is an explanatory view of the concept of the type table;

FIG. 6 is a flowchart of the printing process;

FIGS. 7A to 7C show screen display in the printing process; and

FIGS. 8A to 8C show the display of a guide to a slot.

### DETAILED DESCRIPTION OF THE PREFERRED EMBODIMENTS

With reference to the attached drawings, an embodiment of the present invention will be explained below.

[General Configuration]

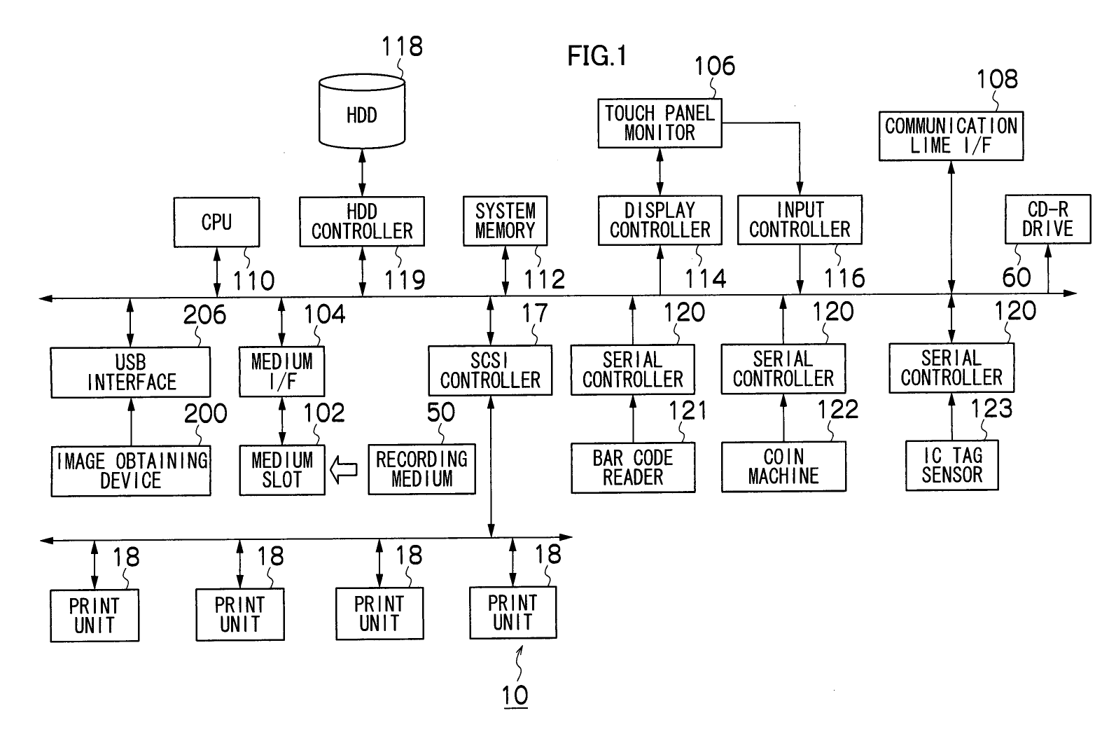

FIG. 1 is a block diagram of a printer 10 according to a preferred embodiment of the present invention. The printer 10 comprises a medium slot 102 into which a recording medium 50 such as SmartMedia, MemoryStick, CompactFlach (registered trademark), etc., a medium interface 104, a monitor 106 with a touch panel, and a communication line interface 108 capable of transmitting and receiving necessary information over a network such as the Internet, etc. The monitor 106 with a touch panel displays a list of images recorded on the recording medium 50 inserted into the medium slot 102 or the images transmitted through the communication line interface 108, and various operation buttons. The printer 10 is also provided with a USB interface 206 for data communication with equipment such as a scanner, a digital camera, etc.

The printer 10 comprises a central processing unit (CPU) 110 for controlling the entire printer 10, system memory 112 configured by ROM on which a program, etc. for operating the CPU 110 is written and RAM as a work area used when the CPU 110 performs a process, a display controller 114 for outputting information displayed on the monitor 106 with a touch panel, and an input controller 116 for receiving input of various types of information with a pressure applied to the monitor 106 with a touch panel. A print unit 18 is connected to the CPU 110 through a SCSI controller 17, and performs a printing operation at an instruction of the CPU 110.

The printer 10 comprises a hard disk unit (HDD) 118 for temporarily storing an image, print job data, etc. fetched from the recording medium 50 inserted into the medium slot 102, and an HDD controller 119 for controlling storage of information on the HDD 118 or a read of information from the HDD 118.

A bar code reader 121, a coin machine 122, and an IC tag sensor 123 are connected to a serial controller 120. The IC tag sensor 123 receives a radio signal transmitted from the IC tag attached to an article such as the recording medium 50, etc., reads the information recorded on the IC tag, and outputs it to the CPU 110. The bar code reader 121 reads the bar code information added to an article such as the recording medium 50, etc., and outputs it to the CPU 110. When a bar code and an IC tag into which the type of recording medium can be embedded can be applied to the recording medium 50, the type of the recording medium 50 can be read from the bar code and the IC tag, and output to the CPU 110.

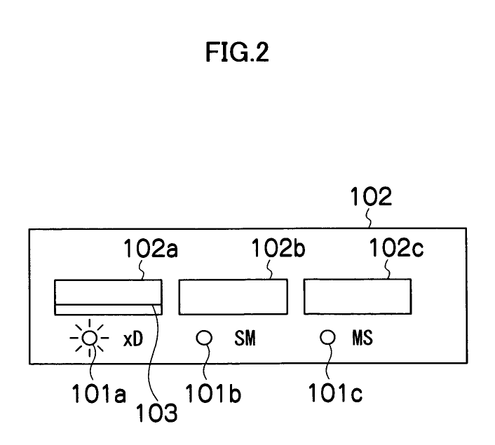

As shown in FIG. 2, the medium slot 102 is separately provided for each type of recording medium 50. In FIG. 2, for example, a slot 102a for xD-Picture Card (xD), a slot 102b for SmartMedia (SM), and a slot 102c for MemoryStick (MS) are provided. LEDs 101a to 101c for guiding the recording medium 50 to the respective slots are provided near the slots 102a to 102c respectively. A shutter 103 can be provided for each of the slots 102a to 102c. A user inserts the recording medium 50 into the medium slot 102 corresponding to the type of the recording medium 50, deposits coin into the coin machine 122, and prints the digital image stored in the recording medium 50 on the print unit 18.

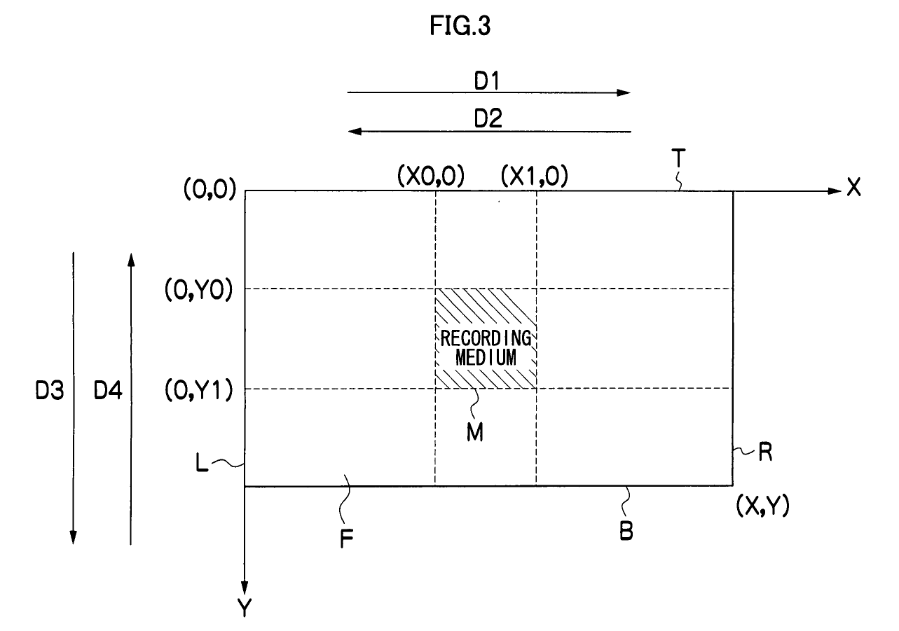

By referring to FIG. 1, an image obtaining device 200 is configured by various scanners such as a CCD scanner, etc., and is connected to the CPU 110 through a USB interface 206. The image obtaining device 200 scans the recording medium 50 set on the mount (to be entirely white if it is possible) not shown in FIG. 1, reads the planar shape of the recording medium 50, and converts it to an image. The image is output to the CPU 110. FIG. 3 shows an example of the image showing the planar shape of the recording medium 50 (hereinafter referred to as an image for the recognizing process). As shown in FIG. 3, an image for the recognizing process shows the state in which the planar shape M of the recording medium 50 is arranged in the background F obtained by reading the mount portion.

The image obtaining device 200 can be configured by various imaging devices such as a digital camera, a video camera, etc. That is, the planar shape of the recording medium 50 can be captured by any of various imaging devices, and an image obtained in the capturing process can be output as an image for the recognizing process to the CPU 110.

[Flow of Process]

Described below is the process performed by the CPU 110. The CPU 110 performs the recording medium recognizing process of determining the type of the recording medium 50 from the image for the recognizing process. The process is a subroutine process in the printing process described later.

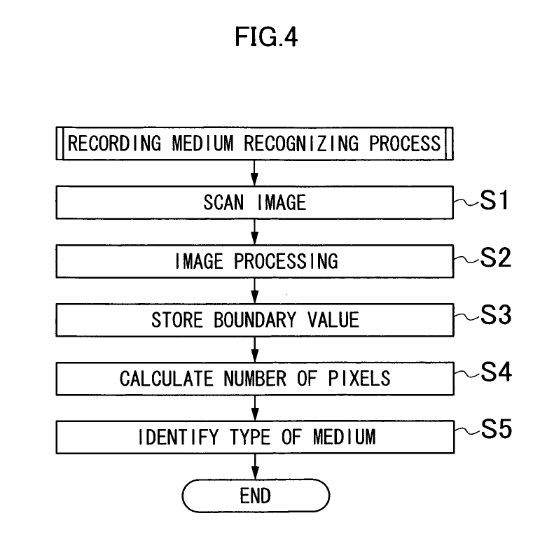

FIG. 4 is a flowchart of the recording medium recognizing process.

In S1, the image obtaining device 200 scans the shape of the recording medium 50 set on the mount when the read button of the image obtaining device 200 not shown in the attached drawings is pressed. In S2, the image obtaining device 200 outputs to the CPU 110 the image for the recognizing process obtained by performing image processing such as various amendments, etc. on the image obtained by the scanning process.

In S3, the CPU 110 determines a boundary value for determination of the boundary between an image M and a background F based on the image for the recognizing process output from the image obtaining device 200. A boundary value is determined as follows. That is, as shown in FIG. 3, on the XY plane formed by the X coordinates axis parallel to the primary scanning direction of the recording medium 50 and the Y coordinates axis orthogonal to the X coordinates axis, the RGB values of two adjacent pixels of the image for the recognizing process are sequentially obtained along the positive direction D1 and the negative direction D2 of the X coordinates, and the positive direction D3 and the negative direction D4 of the Y coordinates, the adjacent pixels are compared to detect a change in color or brightness, the coordinates position of the pixel detected as a change is stored as a boundary value in the system memory 112.

If the mount is entirely white, the condition of obtaining an image is set in the image obtaining device 200 such that the RGB value the background F can be almost (230, 230, 230). Assuming that the color or brightness of a pixel is changed if the RGB value of one pixel in comparison is smaller than (230, 230, 230), it is easy to detect a change in color or brightness.

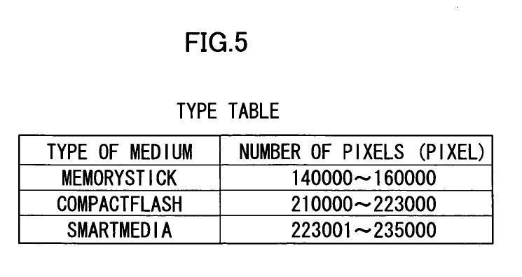

In S4, the CPU 110 calculates the number of pixels in the image M enclosed by the pixels positioned at the coordinates of the boundary values. Then, the CPU 110 identifies the type of the recording medium 50 based on the calculated number of pixels in the image M. For example, as shown in FIG. 5, the type table defining the correspondence between the number of pixels and the type of the recording medium 50 is stored in the system memory 112, and the type of the recording medium 50 corresponding to the number of pixels calculated in S4 is identified from the type table. The type of the recording medium 50 is stored in the system memory 112.

The CPU 110 identifies the type of the recording medium 50 as described above, guides the recording medium 50 to an appropriate medium slot 102, and performs an image printing process.

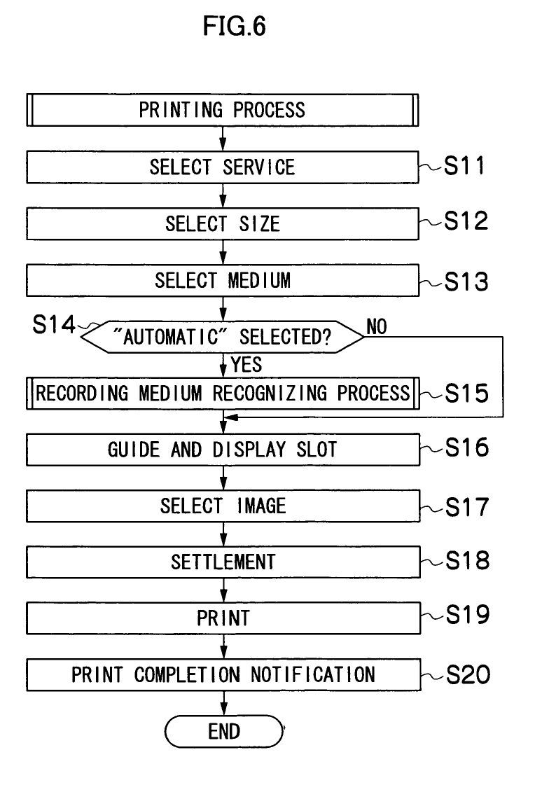

FIG. 6 is a flowchart of the printing process.

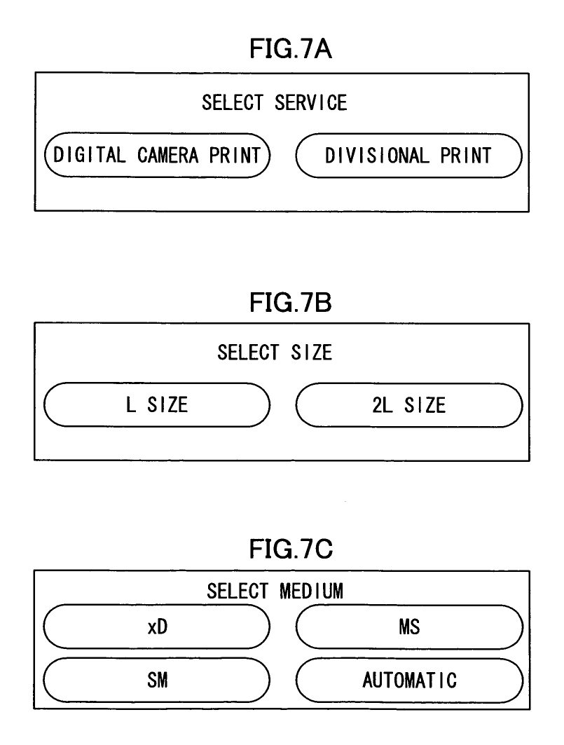

In S11, the display controller 114 allows the selection button of the print type to be displayed on the monitor 106 with a touch panel, and the input controller 116 accepts the selection. The print type can be selected from between the “digital camera print” for printing one image on one print medium and the “divisional print” for printing an image on a print medium of the same size as the digital camera print by reducing in predetermined number of images (for example, in four image units) (refer to FIG. 7A).

In S12, the display controller 114 displays the selection button of the print size on the monitor 106 with a touch panel, and the input controller 116 accepts the selection. For example, relating to the print size, an L size or a 2L size can be selected (refer to FIG. 7B).

In S13, the display controller 114 displays the selection button of the medium type on the monitor 106 with a touch panel, and the input controller 116 accepts the selection. The medium type refers to the type of the recording medium 50 to be inserted into the medium slot 102, and for example, xD-Picture Card (xD), SmartMedia (SM), and MemoryStick (MS) (refer to FIG. 7C). When the type of the recording medium 50 is uncertain, the “automatic” button is selected.

In S14, it is determined whether the “automatic” button has been selected, or a button for any other medium type has been selected. If the “automatic” button is selected, control is passed to step S15. If the selection button of any other type of medium is pressed, control is passed to step S16. When the “automatic” button is selected, the recording medium 50 is placed on the mount of the image obtaining device 200, and is displayed on the monitor 106 with a touch panel, and an instruction is issued to a user.

In S15, the above-mentioned recording medium recognizing process is performed, and the type of the recording medium 50 is identified based on the image for the recognizing process. Instead of scanning of the recording medium 50 using the image obtaining device 200, the type of the recording medium 50 can be identified according to the information read from a bar code or an IC tag applied to the recording medium 50.

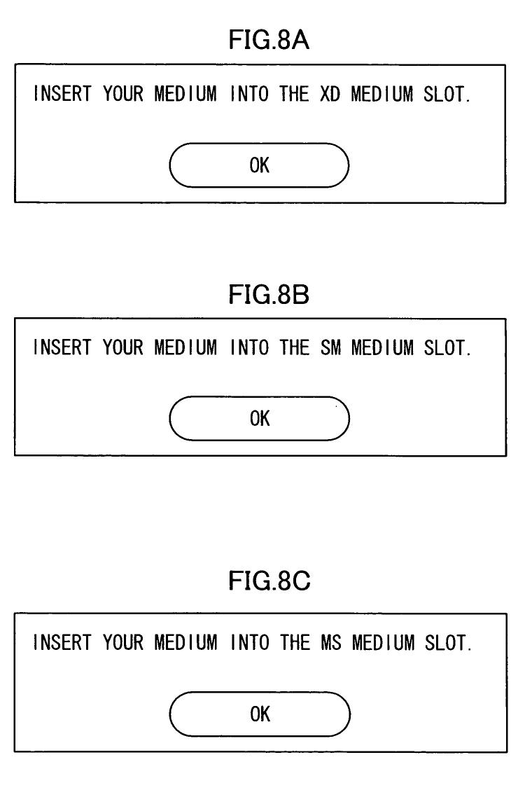

In S16, the type of the recording medium 50 identified by a press of the selection button of the medium type in S13 or in the process in S15, and the information for guide to the medium slot 102 corresponding to the type are displayed on the monitor 106 with a touch panel. That is, if the selection button of the xD-Picture Card (xD) is pressed or if the type of the recording medium 50 is identified as an xD-Picture Card in S15, then a guide for insertion of the recording medium 50 into the slot 102a of the xD Picture Card is displayed (refer to FIG. 8A). Otherwise, if the selection button of the SmartMedia (SM) is pressed or the type of the recording medium 50 is identified as SmartMedia, a guide for insertion of the recording medium 50 into the slot 102b of the SmartMedia is displayed (refer to FIG. 8B). Otherwise, if the selection button for the MemoryStick (MS) is pressed or the type of the recording medium 50 is identified as MemeryStick in S15, a guide for insertion of the recording medium 50 into the slot 102c for MemoryStick is displayed (refer to FIG. 8C). With the above-mentioned display of the guide, a lighting device such as the LED 101 provided near the medium slot 102 corresponding to the identified or selected type can blink or be lighted. Also, the shutter 103 of the medium slot 102 corresponding to the identified or selected type can be opened.

In S17, the CPU 110 reads a sample image (thumbnail image) of the image from the recording medium 50 inserted into the medium slot 102, and stores it in the system memory 112. The display controller 114 lists the sample image stored on the system memory 112 on the monitor 106 with a touch panel and the input controller 116 accepts the selection. The input controller 116 can accept the operation of enlarging, reducing and rotating the selected image. The display controller 114 displays the button (“OK” button, etc.) for issue of an instruction to print a selected image on the monitor 106 with a touch panel, and the input controller 116 accepts the instruction to print the selected image.

In S18, upon receipt of the instruction to print the image, the display controller 114 displays a prompt for input of the fee for a print image to the coin machine 122 on the monitor 106 with a touch panel. When the amount input to the coin machine 122 exceeds the fee for the print image, the coin machine 122 settles the fee, and control is passed to S19.

In S19, the CPU 110 generates print data based on the print size indicated by the original image of the sample image selected in S17, and stores it in the HDD 118. The print unit 18 performs an image printing process according to the print data stored in the HDD 118. In S20, the display controller 114 displays the notification that the printing process has been completed on the monitor 106 with a touch panel, thereby terminating the process.

The CPU 110 can output the original image of the sample image selected in S17 to the CD-R medium inserted into a CD-R drive 60, and record it. The CPU 110 can also transmit the original image of the sample image selected in S17 from the monitor 106 with a touch panel to a specified network address through the communication line interface 108.

As described above, the printer 10 identifies the type of the recording medium 50 based on the image for the recognizing process showing the shape of the recording medium 50 taken from the image obtaining device 200, and guides and displays the recording medium 50 to be inserted into the medium slot 102 corresponding to the type. Since it is not necessary as in the conventional method for a user to determine the type of the recording medium 50, a user can be prevented from mistakenly inserting the recording medium 50 into the medium slot 102 inappropriate for the type of the user presented recording medium 50.

What is claimed is:

1. A printer, comprising:
an image read unit which has slots corresponding to types of recording media, and reads an image from a recording medium inserted into the slot;
an image obtaining unit which obtains an image showing a shape of the recording medium;
an identifying unit which identifies the type of recording medium based on the image showing the shape of the recording medium;
a guide unit which guides to and displays a slot corresponding to the identified type; and
a print unit which prints the image read from the recording medium.

2. The printer according to claim 1, wherein
the guide unit displays the identified type on a display device.

3. The printer according to claim 1, wherein
the guide unit turns on a lighting device provided near the slot corresponding to the identified type.

4. The printer according to claim 1, wherein
the guide unit opens a shutter provided at the slot corresponding to the identified type.

5. The printer according to claim 1, further comprising
a storage unit which stores a table defining correspondence between the type of the recording medium and a number of pixels of an image showing the shape of the recording medium, wherein
the identifying unit identifies the type of the recording medium based on the number of pixels of the image showing the shape of the recording medium and the table.

6. The printer according to claim 2, further comprising
a storage unit which stores a table defining correspondence between the type of the recording medium and a number of pixels of an image showing the shape of the recording medium, wherein
the identifying unit identifies the type of the recording medium based on the number of pixels of the image showing the shape of the recording medium and the table.

7. The printer according to claim 3, further comprising
a storage unit which stores a table defining correspondence between the type of the recording medium and a number of pixels of an image showing the shape of the recording medium, wherein
the identifying unit identifies the type of the recording medium based on the number of pixels of the image showing the shape of the recording medium and the table.

8. The printer according to claim 4, further comprising
a storage unit which stores a table defining correspondence between the type of the recording medium and a number of pixels of an image showing the shape of the recording medium, wherein
the identifying unit identifies the type of the recording medium based on the number of pixels of the image showing the shape of the recording medium and the table.

9. A method for guide to a slot of a recording medium, comprising the steps of:
obtaining an image showing a shape of the recording medium;
designating the type of recording medium based on the image showing the shape of the recording medium; and
guiding to and displaying a slot corresponding to the identified type.

10. An image output apparatus, comprising:
an image read unit which has a slot corresponding to a type of recording medium, and reads an image from a recording medium inserted into the slot;
an image obtaining unit which obtains an image showing a shape of the recording medium;
an identifying unit which identifies the type of recording medium based on the image showing the shape of the recording medium;
a guide unit which guides to and displays a slot corresponding to the identified type; and
an image output unit which outputs the image read from the recording medium.
